(19) United States
(12) Patent Application Publication
(10) Pub. No.: US 2026/0354534 A1
(43) Pub. Date: Nov. 12, 2026

(54) METHOD FOR PRODUCING A SHOE COMPONENT AND SHOE COMPONENT

(71) Applicant: ON CLOUDS GMBH, CH-8005 ZÜRICH (CH)

(72) Inventors: Johannes VOELCHERT, Zürich (CH); Martin RÜEGG, Zürich (CH); Thomas BELL, Zürich (CH)

(73) Assignee: ON CLOUDS GMBH, CH-8005 ZÜRICH (CH)

(21) Appl. No.: 19/135,159

(22) PCT Filed: Dec. 19, 2023
(86) PCT No.: PCT/EP2023/086525

§ 371 Date: Jun. 3, 2025

(30) Foreign Application Priority Data
Dec. 19, 2022 (CH) CH001516/2022
Aug. 31, 2023 (CH) CH000930/2023

(51) Int. Cl. A43B 23/02

(52) U.S. Cl. CPC A43B 23/0255

(57) ABSTRACT

A method for producing a shoe component and/or a shoe includes providing a sole unit having a thermoplastic rim portion; arranging a last on the sole unit; and heating the thermoplastic rim portion such that the thermoplastic rim portion becomes flowable and/or melts and/or softens to provide a heated thermoplastic rim portion. A molten thermoplastic upper material is then applied onto the thermoplastic rim portion and/or onto the heated thermoplastic rim portion to produce an upper component. The molten thermoplastic upper material having been applied onto the thermoplastic rim portion and/or onto the heated thermoplastic rim portion and the heated thermoplastic rim portion is cured to provide a locking engagement between the upper component and the sole unit.

### BACKGROUND OF THE INVENTION

### Field of the Invention

The present invention lies in the field of shoe production and relates to a method for producing a shoe component, in particular a shoe, as well as to a shoe component which is preferably obtained by such a method.

### Discussion of Related Art

Various different production methods for shoes are known in the prior art. Traditionally, sole units are foamed, e.g. foam molded, and uppers are separately manufactured as textiles by traditional knitting. Furthermore, it is also possible to produce massive and solid uppers as known for example from ski boots, by injection molding or additive manufacturing, such as 3D-printing.

One advantage of additive manufacturing is that the upper can in general be individually adjusted to the wearer's foot. However, while additive manufacturing of massive and solid uppers is relatively straightforward, the additive manufacturing of textiles having an ordered pattern, such as a knitted or woven pattern is still challenging. For example, a common problem is the unwanted material bonding between different printed filaments and fibers or also the high costs per manufactured upper.

During the production of shoes, the upper and the sole are usually fabricated individually and are then joined together in a separate, additional process step. Most commonly, upper and sole are connected by stitching, typically by Strobel stitching. It is also possible to use an external gluing agent, i.e. to glue the upper to the sole.

A common problem with the known production methods is that they all rely on a separate and additional process steps for connecting upper and sole. Additionally, because stitching connections are typically not liquid tight, i.e. waterproof, an additional cementing layer is often applied. This not only renders the process less efficient, but also represents a health hazard for workers, since the ingredients of such cements may contain hazardous materials.

It is therefore a general object of the present invention to advance the state of the art in the field of shoe technology, in particular shoe production, and preferably to overcome the disadvantages of the prior art fully or at least partly. In advantageous embodiments, a production method for a shoe component is provided which is more efficient than the known methods. In further advantageous embodiments, a method is provided which allows for a safer production process. In further advantageous embodiments, a method is provided which allows to easily adjust the production of the shoe component to the individual conditions of the foot of a specific wearer.

### SUMMARY OF THE INVENTION

The general object is achieved by the subject-matter of the independent claims. Further advantageous embodiments follow from the dependent claims and the overall disclosure. According to a first aspect, the general object is achieved by a method for producing a shoe component. The shoe component may preferably be a shoe, such as a sports shoe. The method comprises the steps:
a. Providing a sole unit, which comprises a thermoplastic rim portion.
b. Arranging a last, particularly a shoe last, on the sole unit. The last may for example be arranged such on the sole unit that the side of the sole unit including the thermoplastic rim portion faces the last.
c. Heating the thermoplastic rim portion, in particular such that the thermoplastic rim portion becomes flowable and/or melts and/or softens, to provide a heated thermoplastic rim portion. Softening means that the heated thermoplastic rim portion is softer than before heating. For example, the heated thermoplastic rim portion may have a lower Asker C value than before step c.
d. Applying a molten thermoplastic upper material onto the thermoplastic rim portion and/or onto the heated thermoplastic rim portion to produce an upper component. In the first case, i.e. when the molten thermoplastic upper material is applied onto the thermoplastic rim portion, which is not heated, the heated thermoplastic rim portion (step c.) may for example be provided during and/or due to the application of the molten thermoplastic upper material. In the latter case, i.e. when the molten thermoplastic upper material may be applied onto the already heated thermoplastic rim portion, the thermoplastic rim portion is first heated and then the molten thermoplastic upper material is applied onto it.
e. Curing both the molten thermoplastic upper material, which has been applied onto the thermoplastic rim portion and/or onto the heated thermoplastic rim portion, and the heated thermoplastic rim portion, thereby providing a locking engagement between the upper component and the sole unit. Preferably, the locking engagement is a material bonding engagement and optionally also a form-locking engagement. In step e. curing of the molten thermoplastic upper material and curing of the heated (and thus flowable and/or melted and/or softened) thermoplastic rim portion is performed together, e.g. simultaneously.

As understood by the skilled person, a last is a shape-providing element which has the shape of a human foot.

It is generally understood herein that the term “comprising” is interpreted as meaning that it includes those features following this term, but that it does not exclude the presence of other features, as long as they do not render the claim unworkable. On the other hand, if the wording “consist of” is used, then no further features are present in the corresponding apart from the ones following said wording.

The term “heated thermoplastic rim portion” as used in step c. means that it has a higher temperature after step c. than for example the thermoplastic rim portion in step a. or after curing in step e. Thus, a heated thermoplastic rim portion is typically flowable and/or melted and/or softened. In particular, the heated thermoplastic rim portion has a temperature above room temperature (23 °C) and preferably a temperature equal to the melting temperature of the thermoplastic rim portion.

It is further understood that the steps mentioned above and being referenced as steps a. to e. do not have to be performed in this order, although this may in some embodiments be the case. In particular, the references “a.”, “b.”, “c.”, “d.”, “e.” shall not be understood to provide a particular order of steps, but instead serve the purpose to identify and differentiate the corresponding steps of the method according to the invention. Thus, it may be possible that step c. is performed for example before, after or together with step b. It may in some embodiments also be possible to perform step d. before step c., or to perform steps c. and d. together. Thus, heating and/or softening of the thermoplastic rim portion may be achieved by the application, in particular only by the application, of the molten thermoplastic upper material. Instead of using the references “a.”, “b.”, “c.”, “d.”, “e.” hyphens may also be used.

The method according to the invention has the advantage that the production of the upper component and the connection of upper component and sole unit is performed together in a single process step. This is because the upper is applied as a molten thermoplastic upper material directly onto the thermoplastic rim portion and/or onto the heated thermoplastic rim portion. Therefore, curing achieves both the generation of the upper and concomitantly the connection between upper and sole unit. Furthermore, since both the thermoplastic rim portion and the thermoplastic upper material are molten and/or flowable and/or softened during application of the thermoplastic polymer material onto the thermoplastic rim portion or at least before curing of the molten thermoplastic upper material and the heated rim portion, they undergo a strong and tight connection upon curing. Therefore, additional means to connect upper component and sole unit, such as stitching or separate gluing agents are not required and can be dispensed with. Such embodiments are advantageous as they increase the runner's performance. Without wishing to be bound to a theory, applicant believes that this is caused by a better force transmission of the running movement of the foot through the upper component to the sole unit. Furthermore, since the thermoplastic rim portion is in a molten and/or flowable and/or softened state during application of the thermoplastic upper material or at least before curing of the molten thermoplastic upper material and the heated rim portion, a liquid tight, in particular waterproof connection, is achieved.

Curing in step e. preferably comprises cooling the applied molten thermoplastic upper material and the flowable and/or molten and/or softened thermoplastic rim portion of the sole unit. Cooling may either be an active cooling or allowing the applied molten thermoplastic upper material and the flowable and/or molten and/or softened thermoplastic rim portion (i.e. the heated thermoplastic rim portion) to reach ambient temperature (23 °C) by themselves.

The thermoplastic rim portion of the sole unit may typically be a portion having a certain width and height and forms the periphery of the sole unit. The width of the thermoplastic rim portion typically refers to the extension of the thermoplastic rim portion in the horizontal plane, i.e. the plane being defined by the longitudinal direction and the transversal direction. The thermoplastic rim portion of the sole unit typically has also a certain height, i.e. extension in the vertical direction. The height may typically be between 1% and 60%, particularly between 5% and 50%, more particularly between 10% and 40%, of the total height of the sole unit, i.e. its total extension in the vertical direction. The total height may also be referred to as “thickness” of the sole unit.

Directional indications as used in the present disclosure are to be understood as follows: The longitudinal direction L of the shoe component, is described by an axis from the heel area, respectively from the heel edge, to the forefoot region, respectively to the midsole tip, and thus extends along the longitudinal axis of the shoe component. The transverse direction T of the shoe component extends transversely to the longitudinal axis and substantially parallel to the ground in the operative state. Thus, the transverse direction runs along a transverse axis of the shoe component. In the context of the present invention, the vertical direction V denotes a direction in the direction of the insole, or in the operative state in the direction of the foot of the wearer, and thus runs along a vertical axis of the shoe component. The longitudinal direction, the vertical direction and the transverse direction may all be perpendicular to each other. The indication “horizontal” refers to a plane extending in the longitudinal and the transverse direction and being perpendicular to the vertical direction. The lateral side of the shoe component, respectively the sole unit, is the outer perimeter of the shoe component, respectively the sole unit, between the heel edge and the sole tip, which in the worn state rests against the outer instep of the wearer's foot. The medial side of the shoe component, respectively the sole unit, refers to the inner perimeter of the shoe component, respectively the sole unit, between the heel edge and the sole tip, which is located opposite the lateral side. Thus, in a pair of worn shoes, the medial sides of the two shoes face each other and the lateral sides face away from each other. Furthermore, the shoe component may typically along the longitudinal direction be divided into a forefoot area, a heel area and a midfoot area being arranged between the forefoot area and the heel area. For example, the forefoot area extends from the shoe tip against, i.e. opposite, the longitudinal direction to 30-45% of the total length of the shoe component in the longitudinal direction. The heel area extends, for example, from the heel edge in the longitudinal direction to 20-30% of the total length of the shoe component in the longitudinal direction. The midfoot area extends directly between the heel area and the forefoot area, such that the length in the longitudinal direction of the midfoot area makes up the remaining portion of the total length, particularly from 15-50% of the total length.

In some embodiments, step d. comprises step d1: applying the molten thermoplastic upper material onto the thermoplastic rim portion and/or onto the heated thermoplastic rim portion to produce an upper component and step dl : pressing the applied molten thermoplastic upper material and the heated thermoplastic rim portion together. Such embodiments enhance the tightness and firmness of the engagement between the sole unit and the upper component.

In some embodiments, step d, respectively step d1, comprises additionally the application of the molten thermoplastic upper material onto the last to produce the upper component.

In certain embodiments, the molten thermoplastic upper material is applied such onto the last that is circumferentially surrounds the last, in particular such that it circumferentially surrounds the last horizontally completely. However, in each of these embodiments, the molten thermoplastic upper material is applied such onto the last that the last can be removed from the produced upper component, particularly without destroying the produced upper component. That is, the thermoplastic upper material is applied in such a manner that the upper component defines a foot opening.

Typically, after step e. the last is removed. Thereby, a foot accommodation compartment is formed which corresponds to the shape of the last.

In some embodiments, the molten thermoplastic upper material is applied onto the thermoplastic rim portion and/or onto the heated thermoplastic rim portion, and optionally onto the last, as one or more filaments. That is, either a single filament is continuously applied to the last or multiple filaments are applied to the last, preferably one after the other. However, during application, the filaments are typically separate from each other.

Thus, it may in some embodiments be possible to spray and/or lay and/or apply individual filaments of the molten thermoplastic upper material onto the thermoplastic rim portion and/or onto the heated thermoplastic rim portion and optionally onto the last. In certain embodiments in which multiple filaments are applied, the filaments may have a length of 20 mm or less, in particular of 10 mm or less, in particular of 5 mm or less.

Such embodiments which use one or more filaments have the advantage that on the one hand a specific shape of the upper can be readily and reliably realized. In particular, the last can be designed as an individual model of a specific wearer's foot. It may for example in some embodiments be possible that the method comprises taking a 3D scan of a wearer's foot and manufacturing a last based on this 3D scan, for example by additive manufacturing. Furthermore, using filaments allows to provide and/or mimic a textile structure of the upper. For example, if a plurality of separate filaments are applied, in particular randomly applied, the resulting upper component provides and/or mimics a non-woven. If a single filament is continuously applied to the last, the resulting upper component may provide and/or mimic a knitted upper. If several filaments are applied in an ordered manner, e.g. such that they form a grid structure, the resulting upper component may provide and/or mimic a woven upper.

In some embodiments, the thermoplastic rim portion is in step c. heated to a temperature of 110 °C to 350 °C, in particular 200 °C to 350 °C, more particular 200 °C to 250 °C, more particular 230 °C.

In some embodiments, the molten thermoplastic upper material in step d. has a temperature of 110 °C to 350 °C, in particular 200 °C to 350 °C, in particular 250 °C to 300 °C, more particular 280 °C.

The thermoplastic rim portion may in some embodiments be made from polyester, polyamide, polyether block amide (PEBA), polyurethane, ethylene vinyl acetate (EVA), polyolefin, such as polyethylene or polypropylene, or mixtures thereof. In some embodiments, the whole sole unit may be made from polyester, polyamide, polyether block amide (PEBA), polyurethane, ethylene vinyl acetate (EVA), polyolefin, such as polyethylene or polypropylene, or mixtures thereof.

In some embodiments, the thermoplastic upper material may be polyester, polyamide, polyether block amide (PEBA), polyurethane, ethylene vinyl acetate (EVA), polyolefin, such as polyethylene or polypropylene, or mixtures thereof.

In some embodiments, the molten thermoplastic upper material is applied onto the thermoplastic rim portion and/or onto the heated thermoplastic rim portion, and optionally onto the last, by a nozzle, for example a spray nozzle.

In some embodiments, the nozzle may have a distance to the thermoplastic rim portion of 20 to 50 mm, in particular 30 to 40 mm.

In some embodiments, the nozzle is part of an application unit being movable in the 3-dimensional space. The movement of the application unit in the 3-dimensional space may in preferred embodiments be controlled by a control unit. The control unit may for example comprise a circuit, in particular a microprocessor. The application unit may in some embodiments comprise or be a robotic arm. The application unit can therefore during step d. be moved around the sole unit and/or the last.

In some embodiments, the application unit and the last are moved relative to each other during step d. This may be achieved by moving the application unit in the 3-dimensional space, by moving the last and the sole unit in the 3-dimensional space or by moving the application unit, the last and the sole unit in the 3-dimensional space.

In some embodiments, the nozzle has an outlet opening for the molten thermoplastic upper material and a plurality of air exit openings. The air exit openings are arranged around the outlet opening and pressurized air is supplied through the air exit openings to the molten thermoplastic upper material exiting the outlet opening such that the molten thermoplastic upper material, which has exited from the nozzle, is applied onto the thermoplastic rim portion and/or onto the heated thermoplastic rim portion and/or onto the last as a helical filament. Using a helical filament leads to the formation of a loop-like structure of the upper component with a plurality of crossing but not entangled loops. Thus, it is possible to provide an upper component which provides and/or mimics a knitted textile. However, by preselecting the properties of the helical filament, such as helical pitch, slope or radius, the formed corresponding loops can readily be varied over the upper component. For example, it is possible to use narrower loops by selecting a smaller radius at location with high mechanical stress during running and wider loops at locations where a certain flexibility is advantageous.

In some embodiments, the molten thermoplastic filament may be provided to the thermoplastic rim portion and/or the heated thermoplastic rim portion with a velocity of at least 0.1 m/s, in particular at least 0.5 m/s, more particular at least 0.7 m/s. In some embodiments, the molten thermoplastic filament may be provided to the thermoplastic rim portion and/or the heated thermoplastic rim portion with a velocity of between 0.1 m/s to 10 m/s, in particular between 0.1 m/s to 5 m/s, more particular between 0.1 m/s to 1 m/s. In some embodiments, the molten thermoplastic filament may be provided to the thermoplastic rim portion and/or the heated thermoplastic rim portion with a velocity of between 0.5 m/s to 10 m/s, in particular between 0.5 m/s to 5 m/s, more particular between 0.5 m/s to 1 m/s. In some embodiments the molten thermoplastic filament may be provided to the thermoplastic rim portion and/or the heated thermoplastic rim portion with a velocity of between 0.7 m/s to 10 m/s, in particular between 0.7 m/s to 5 m/s, more particular between 0.7 m/s to 1 m/s.

In some embodiments, the pressurized air has a temperature of 400 °C to 800 °C, in particular 400 °C to 800 °C, more particular 500 °C to 600 °C.

The helical filament may for example have a radius of at least 0.5 mm, in particular of at least 1 mm, in particular of at least 2 mm. For example, the radius may be between 0.5 mm and 20 mm, in particular between 1 mm and 10 mm.

Typically, in such embodiments, only a single helical filament exits the outlet opening and not multiple filaments at the same time.

In some embodiments, the helical filament is at least partially or completely applied as a continuous filament. Thus, the resulting upper component comprises or consists of a plurality of continuous loops which consist of a single continuous filament. For example it may be possible that at least 10, preferably at least 50, more preferably at least 100, more preferably at least 500, more preferably at least 1000 loops are formed from a single continuous filament.

The air exit openings may preferably comprise a horizontal angle β between a horizontal plane, which is perpendicular to the outlet opening and the exiting direction, and the air exit opening, respectively an axis through the air exit opening along which the air is exiting the air exit opening. Furthermore, the air exit openings are along an axis through the corresponding air outlet opening in the direction of flow of the pressurized air, not directly directed to an axis extending in the exiting direction through the center of the outlet opening, but are shifted in horizontal direction thereto, i.e. perpendicular to the discharge direction and the outlet opening, by an angle a. Preferably, the angle a can be between 5°and 35°, in particular between 15°and 30°. In some embodiments, heating in step c. is performed by an IR heater. In certain embodiments, the IR heater is spaced apart from the thermoplastic rim portion during heating. It may also be possible that a stream of heated air is used for heating. For example, the stream of heated air may have a temperature of 400 °C to 800 °C, in particular 450 °C and 700 °C, more particular 500 °C and 600 °C. In some embodiments a flow of heated air is provided onto the thermoplastic rim portion. For this, a heat gun or a related device may be used. The term “heated air” means that the air has a temperature above the melting temperature of the material of the thermoplastic rim portion. The heated air has therefore a temperature which is selected such that the thermoplastic rim portion can become flowable and/or melts and/or softens. In some embodiments, heating in step c. is performed by a heating element being brought in direct contact with the thermoplastic rim portion. In some embodiments, the IR heater is part of the application unit. It may also be possible that the application unit provides the flow of heated air. In some embodiments, the flow of heated air may be the pressurized air being supplied to the molten thermoplastic upper material exiting the outlet opening via the air exit openings of the nozzle.

In some embodiments, the melting temperature of the thermoplastic rim portion is between 150 °C and 300 °C, in particular between 180 °C and 280 °C, more particular between 200 °C and 250 °C

It may in certain embodiments also be possible that step c. i.e. heating the thermoplastic rim portion such that it becomes flowable and/or melts and/or softens is partially or even completely performed by the application of the molten thermoplastic upper material onto the thermoplastic rim portion. In the latter case, i.e. when step c. is performed only (i.e. completely), by the application of the molten thermoplastic upper material onto the thermoplastic rim portion (that is by step d.), the molten thermoplastic upper material is applied onto the thermoplastic rim portion upon which thermal energy is transferred from the applied molten thermoplastic upper material to the thermoplastic rim portion, which heats the thermoplastic rim portion, in particular such that it becomes flowable and/or melts and/or softens.

In some embodiments, the sole unit comprises a central section and the thermoplastic rim portion completely circumferentially surrounds the central section. Preferably, the thermoplastic rim portion directly contacts the central section and/or is arranged directly adjacent the central section. The central section may be made of the same material as the thermoplastic rim portion or it may be made from a different material. In certain embodiments, in which the central section is made from the same material as the thermoplastic rim portion, the thermoplastic rim portion and the central section may be integrally formed, i.e. formed as a single-piece. In particular embodiments, the sole unit may be a single piece sole unit.

In some embodiments, the last in step b. is arranged on the central section. In some embodiments, the last is however not positioned on the thermoplastic rim portion. In certain embodiments, the last is only arranged on the central section of the sole unit.

In alternative embodiments, the last is arranged on both the central section and the thermoplastic rim portion. In particular, the last may be arranged such on the sole unit that sole unit and last are flush with each other or such that the sole unit protrudes from the last, in particular in laterally and/or medially.

In some embodiments, the molten thermoplastic upper material is applied onto the thermoplastic rim portion and/or onto the heated thermoplastic rim portion such that it circumferentially surrounds, preferably completely surrounds, the central section of the sole unit. By circumferentially surrounding the central section, a liquid tight connection, in particular waterproof connection, between sole unit and upper component with high firmness can be provided.

In some embodiments, the thermoplastic rim portion has a width of between 0 mm to 5 mm, particularly >0 mm to 5 mm, more particular of 0.1 mm to 2.5 mm. As outlined above, the width of the thermoplastic rim portion is the extension of the thermoplastic rim portion in the horizontal plane defined by the longitudinal direction and the transversal direction. Although this may in some embodiments be the case, the width of the thermoplastic rim portion does not need to be constant at every position of the thermoplastic rim portion, but can vary, in particular within the ranges provided above.

In some embodiments, the upper component and the sole unit are connected only by the locking engagement provided in step e., e.g. only by the material bonding and optionally form-locking engagement between upper component and sole unit. A form-locking engagement may occur if the applied thermoplastic upper material forms loops, with which the thermoplastic rim portion forms a form locking engagement after curing.

In some embodiments, the connection of the upper component and the sole unit is devoid of stitching and/or separate gluing agent, which enhances the efficiency of the shoe component production. A separate gluing agent is a gluing agent which is additionally added to the thermoplastic rim portion and/or to the thermoplastic upper material but which is not an inherent part of the thermoplastic rim portion and/or to the thermoplastic upper material.

In a second aspect of the invention, the general object is achieved by a shoe component, in particular a shoe. In preferred embodiments, the shoe or shoe component of the second aspect of the invention may be obtained by the method of any of the embodiments described herein, in particular with respect to the first aspect of the invention. The shoe or shoe component comprises a sole unit and an upper component. The sole unit comprises a thermoplastic rim portion. The upper component is made from a thermoplastic upper material. Furthermore, the thermoplastic rim portion and the upper component are connected with each other by a direct material bonding engagement between the thermoplastic rim portion and the upper component. The direct material bonding engagement means that the thermoplastic rim portion and the upper component form together a material bonding engagement, without an external additive, such as a gluing agent.

In some embodiments, the connection between the sole unit and the upper component is devoid of stitching and/or a separate gluing agent.

In some embodiments, the upper component consists of one or more filaments of the thermoplastic upper material. The one or more filaments may be randomly distributed filaments, in particular randomly distributed filaments, which each have a length of 20 mm or less, in particular of 10 mm or less, in particular of 5 mm or less. Alternatively, the one or more filaments may be regularly distributed filaments. In certain embodiments, one or more filaments may each form a loop structure. Each loop structure may consist of multiple loops. Typically, the loops overlap with each other but are not intermingled. I n general, the one or more filaments may be connected to each other by material bonding connections at connection points. In certain embodiments it is also possible that a single filament forms such material bonding connection points with itself.

In some embodiments, the upper is a textile element. In some embodiments, the upper may comprise one or more filaments, preferably being made from the thermoplastic upper material. In particular embodiments, the one or more filaments form a loop structure.

The shoe may in some embodiments comprise a peripheral fused section. In particular, the peripheral fused section may form the direct material bonding engagement between the thermoplastic rim portion and the sole unit. The peripheral fused section may for example be circumferentially arranged around a central section of the sole unit. The fused section may preferably be a section at which the upper component and the sole unit are directly fused together. In certain embodiments, the peripheral fused section circumferentially extends around the central section of the sole unit.

In some embodiments, the upper component of the shoe may have at least one physical property being different from the peripheral fused section, such as a different hardness (e.g. Asker C hardness) and/or porosity and/or density. It may also be possible that the upper component may be a textile element as described above, while the peripheral fused section may be a continuous polymer section, in particular a welding seam.

In some embodiments, the sole unit of the shoe may have at least one physical property being different from the peripheral fused section, such as a different hardness (e.g. Asker C hardness) and/or porosity and/or density. It may also be possible that the sole unit may be a foamed component, while the peripheral fused section may be a continuous polymer section, in particular a welding seam.

In some embodiments, the peripheral fused section may have a height, i.e. extension in the vertical direction, of 1 mm to 20 mm, in particular 5 mm to 15 mm, more particular 5 mm to 10 mm.

In some embodiments the peripheral fused section may have a height between 1% and 60%, particularly between 5% and 50%, more particularly between 10% and 40%, of the total height of the sole unit, i.e. its total extension in the vertical direction.

In some embodiments, the peripheral fused section may comprise a plurality of fused loop structures.

The following examples disclose further aspects and embodiments of the invention. These example may also be combined with any of the other embodiments described herein:
Example 1: Method for producing a shoe component, in particular a shoe, the method comprising the steps of:
a. Providing a sole unit, wherein the sole unit comprises a thermoplastic rim portion
b. Arranging a last on the sole unit;
c. Heating the thermoplastic rim portion such that the thermoplastic rim portion becomes flowable and/or melts to provide a heated thermoplastic rim portion;
d. Applying a molten thermoplastic upper material onto the heated thermoplastic rim portion to produce an upper component;
e. Curing the molten thermoplastic upper material having been applied onto the heated thermoplastic rim portion and the heated thermoplastic rim portion to provide a locking engagement, in particular a material bonding and optionally a form-locking engagement, between the upper component and the sole unit.
Example 2: The method according to example 1, wherein step d. further comprises to apply the molten thermoplastic upper material onto the last to produce the upper component.
Example 3: The method according to example 1 or 2, wherein the molten thermoplastic upper material is applied onto the heated thermoplastic rim portion, and optionally the last, as one or more thermoplastic filaments.
Example 4: The method according to any of the previous examples, wherein the thermoplastic rim portion is in step c. heated to a temperature of 110 °C to 350 °C, in particular 200 °C to 250 °C, more particular 230 °C.
Example 5: The method according to any of the previous examples, wherein the molten thermoplastic upper material is applied onto the heated thermoplastic rim portion, and optionally the last, by a nozzle.
Example 6: The method according to example 5, wherein the nozzle is part of an application unit being movable in the 3-dimensional space and wherein movement of the application unit is optionally being controlled by a control unit.
Example 7: The method according to example 6, wherein the application unit and the last are moved relative to each other during step d.
Example 8: The method according to any of examples 5 to 7, wherein the nozzle has an outlet opening for the molten thermoplastic upper material and a plurality of air exit openings, wherein the air exit openings are arranged around the outlet opening and wherein pressurized air is supplied to the molten thermoplastic upper material exiting the outlet opening such that the molten thermoplastic upper material which has exited from the nozzle is applied to the last as a helical filament.
Example 9: The method according to any of the previous examples, wherein in step c. heating is performed by an IR heater, by applying a stream of heated air and/or by a heating element being in direct contact with the thermoplastic rim portion.
Example 10: The method according to any of the previous examples, wherein the sole unit comprises a central section, wherein the thermoplastic rim portion completely circumferentially surrounds the central section.
Example 11: The method according to example 10, wherein the last is in step b. arranged on the central section, in particular only on the central section.
Example 12: The method according to example 10 or 11, wherein in step d. the molten thermoplastic upper material is applied such onto the heated thermoplastic rim portion that it circumferentially completely surrounds the central section.
Example 13: The method according to any of the previous examples, wherein the thermoplastic rim portion has a width w of between >0 mm to 5 mm, in particular of 0.1 mm to 2.5 mm.
Example 14: The method according to any of the previous examples, wherein the upper component and the sole unit are connected only by the locking engagement and/or wherein a connection of the upper component and the sole unit is devoid of stitching and/or a separate gluing agent.
Example 15: Shoe component, being preferably obtained by the method according to any of the previous examples, the shoe comprising a sole unit and an upper component, wherein the sole unit comprises a thermoplastic rim portion and wherein the upper component is made from a thermoplastic upper material, wherein the sole unit and the upper component are connected with each other by a direct material bonding engagement between the thermoplastic rim portion and the upper component.
Example 16: The shoe component according to example 15, wherein the connection between the sole unit and the upper component is devoid of stitching and/or a separate gluing agent.

### BRIEF DESCRIPTION OF SEVERAL VIEWS OF THE DRAWINGS

The herein described invention will be more fully understood from the detailed description given herein below and the accompanying drawings which should not be considered limiting to the invention described in the appended claims.

FIG. 1A shows one step of the method according to an embodiment of the invention;

FIG. 1B shows another step of the method according to this embodiment;

FIG. 1C shows another step of the method according to this embodiment;

FIG. 1D shows another step of the method according to this embodiment;

FIG. 1E shows another step of the method according to this embodiment;

FIG. 2 shows the application of a molten thermoplastic upper material onto a heated thermoplastic rim portion according to another embodiment of the invention;

FIG. 3a shows a nozzle in one embodiment of the invention;

FIG. 3b shows a nozzle in one embodiment of the invention;

FIG. 4A shows one step of the method according to an embodiment of the invention;

FIG. 4B shows another step of the method according to this embodiment;

FIG. 4C shows another step of the method according to this embodiment;

FIG. 4D shows another step of the method according to this embodiment; and

FIG. 4E shows another step of the method according to this embodiment.

### DETAILED DESCRIPTION OF THE INVENTION

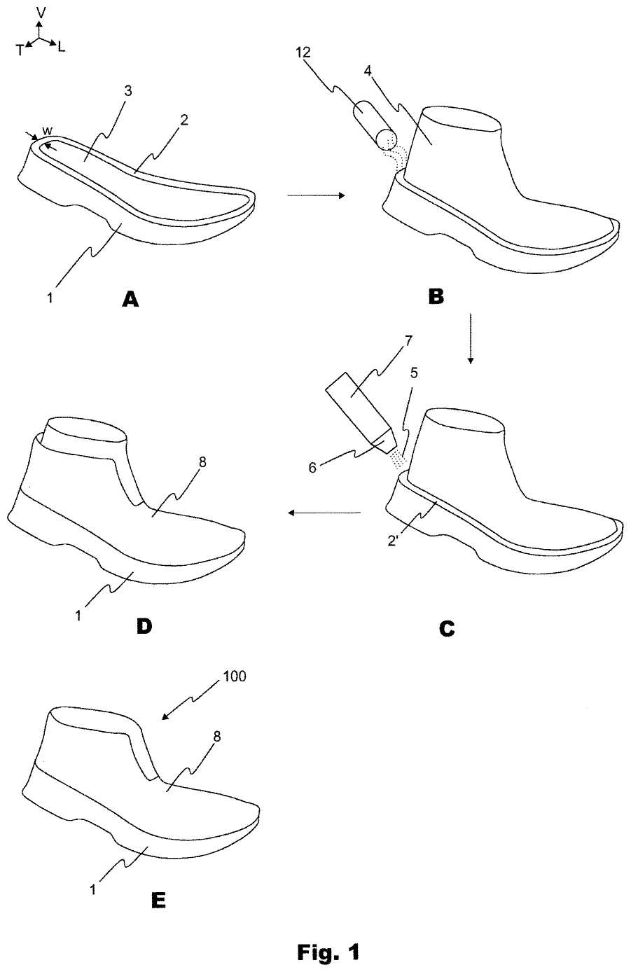

FIG. 1 shows a process scheme of a method for producing a shoe component 100. In A, a sole unit 1 is provided. Sole unit 1 comprises thermoplastic rim portion 2 having width w, which circumferentially completely surrounds central section 3. It should be noted that the width w is drawn in exaggeration for clarity purposes. Then, in B, a last 4 is arranged on sole unit 1, in particular on central section 3. Furthermore, thermoplastic rim portion 2 is heated, in this case by an IR heater 12 until it melts and/or until it becomes flowable and/or softens and/or melts. It is understood that heating comprises raising the temperature of thermoplastic rim portion, typically at least above room temperature (23 °C) or more. By heating thermoplastic rim portion 2, heated thermoplastic rim portion 2′ is provided (see C). Then, molten thermoplastic upper material 5 is applied onto heated thermoplastic rim portion 2′ by means of a nozzle 6. In this embodiment, the nozzle is a spray nozzle and the molten thermoplastic upper material is sprayed onto heated thermoplastic rim portion 2′ and further on last 4. Nozzle 6 is part of an application unit 7 which is movable in the 3-dimensional space. Upon curing the molten thermoplastic upper material which has been applied to heated thermoplastic rim portion 2′ (see D) a locking engagement, in particular a material bonding engagement and optionally a form locking engagement is established between upper component 8 and sole unit 1. In this or any other embodiment described herein, the last 4 can then be removed to provide shoe component 100 (see E).

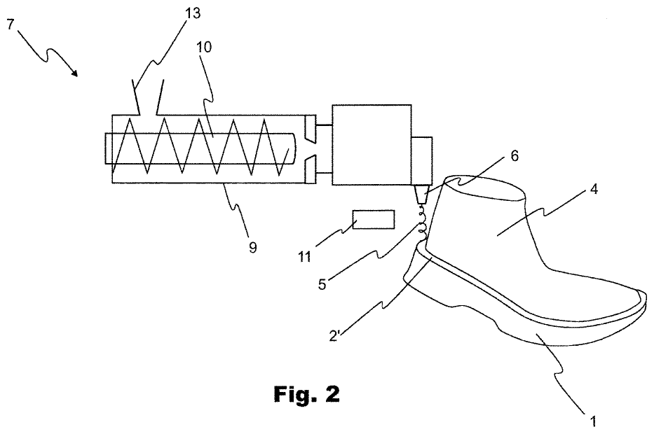

FIG. 2 shows the step of applying the molten thermoplastic upper material on the heated thermoplastic rim portion 2′ and optionally last 4, according to another embodiment of the invention. Therein, application unit 7 comprises barrel 10 and screw 9 being arranged inside barrel 10. Barrel 10 and screw 9 form together an extrusion unit. That is, thermoplastic upper material can be fed into the extrusion unit, particularly through the funnel shaped feeder. Typically, the thermoplastic upper material is fed in the solid state into the extrusion unit and for example in the form of a granulate. Inside the extrusion unit, the thermoplastic upper material is then molten and pressed towards and through nozzle 6. The application unit 7 is movable in the 3-dimensional space such that it can be moved relative to sole unit 1 and last 4.

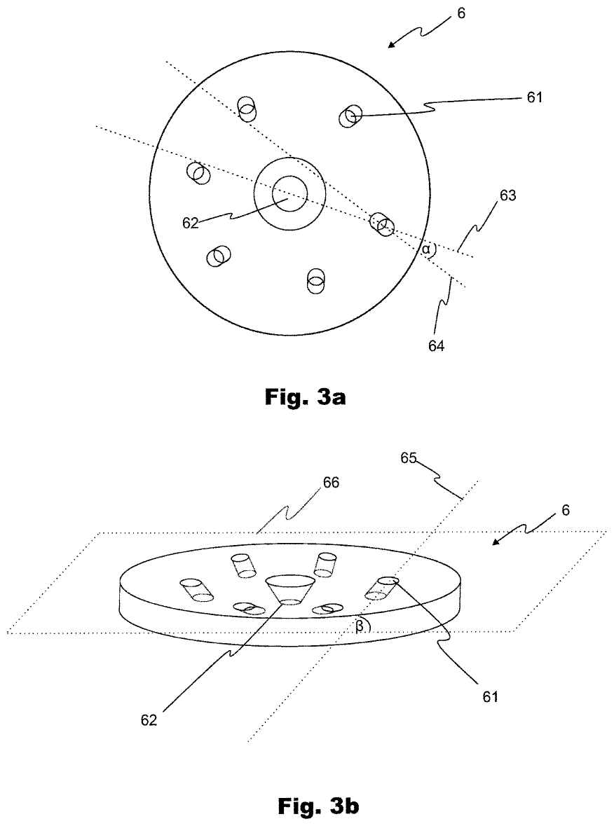

Nozzle 6 as used in this embodiment has an outlet opening for the molten thermoplastic upper material 5 and a plurality of air exit openings (outlet opening and air exit openings are not shown in FIG. 2, see FIGS. 3a and b for a detailed view of nozzle 6). The air exit openings are arranged around the outlet opening and pressurized air is supplied to the molten thermoplastic upper material 5 exiting the outlet opening in such a manner that the molten thermoplastic upper material 5 which has exited from the nozzle 6 is applied to the last as a helical filament. As can be seen, exiting molten thermoplastic material 5 forms a single helical filament between heated thermoplastic rim portion 2′ and nozzle 6. Due to the movement of the application unit 7 relative to sole unit 1 and last 4, this results in the formation of a upper component consisting of a plurality of loops. The loops are crossing each other, but are not intermingled with each other.

FIG. 3a shows a schematic top view of a nozzle 6 as used in the application unit 7 of FIG. 2. As shown in FIG. 3a, air exit openings 61 are not directly directed towards the outlet opening 62 of the nozzle. Nozzle 6 has six such air exit openings 61 (for the sake of clarity, only one of the air exit openings is designated). These are directed along axis 64 through the corresponding air outlet opening in the direction of flow of the compressed air, not directly towards an axis 63 extending in the direction of discharge through the center of the outlet opening, but are displaced by an angle a for this purpose in the horizontal direction, i.e. perpendicular to the discharge direction and the outlet opening 62. The angle a along the air exit openings, i.e. along an axis 64 through the corresponding air exit opening in the direction of flow of the compressed air to an axis 63 directed directly towards the outlet opening 62, can be between 5° and 35°, in particular between 15° and 30°. FIG. 3 b shows a schematic side view of the nozzle 6 as used in the application unit 7 of FIG. 2. The horizontal angle β between the horizontal plane 66, which is perpendicular to the discharge direction, and the air exit opening (for better clarity, the direction of the air outlet opening 61 is shown by axis 65) is between 40° and 60°, preferably between 50° and 60°, in particular 55°. The arrangement of the air exit openings relative to the outlet opening 62 allows to direct pressurized air onto the molten thermoplastic upper material 5 such that it is applied to the heated thermoplastic rim portion as a helical filament.

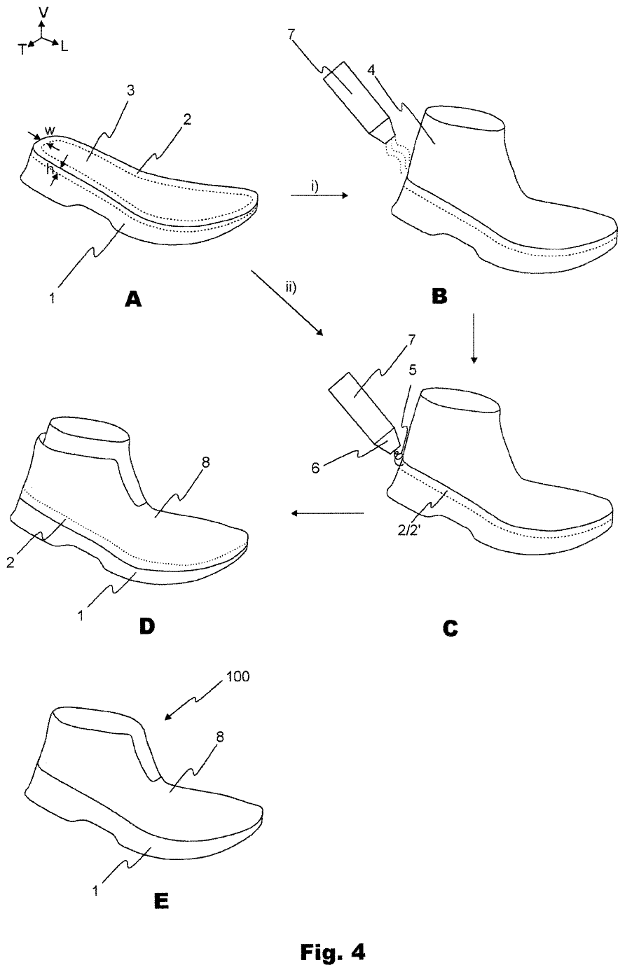

FIG. 4 shows a process scheme of a method for producing a shoe component 100 according to another embodiment of the invention. In A, a sole unit 1 is provided. Sole unit 1 comprises thermoplastic rim portion 2 having width w and height h, which circumferentially completely surrounds central section 3. It should be noted that the width w is drawn in exaggeration for clarity purposes.

Then, in B, a last 4 is arranged on sole unit 1 in contrast to the embodiment shown in FIG. 1, it can be seen that the last is arranged on both central section 3 and rim portion 2 and particularly such that last 4 and sole unit 1 are flush with each other. Furthermore, thermoplastic rim portion 2 is heated, in this case by a hot air stream (i.e. a heated air stream having a temperature above room temperature [23 °C] and particularly above the melting temperature of the thermoplastic rim portion) of application unit 7 which comprises also nozzle 6 as described further below. For example, this air stream may be the pressurized air being provided on the molten thermoplastic upper material exiting the outlet opening of the nozzle (see above). Thermoplastic rim portion 2 is heated by a stream of hot air provided by application unit 7 until it melts and/or until it becomes flowable and/or softens. It is understood that heating comprises raising the temperature of thermoplastic rim portion, typically at least above room temperature (23 °C) or more. By heating thermoplastic rim portion 2, heated thermoplastic rim portion 2′ is provided (see C). In this embodiment, the thermoplastic rim portion 2 is first heated and then the application of the molten thermoplastic upper material is performed (see C). This embodiment is illustrated by path i). Then, molten thermoplastic upper material 5 is applied onto heated thermoplastic rim portion 2′ by means of a nozzle 6. In this embodiment, the nozzle is a nozzle as shown in FIG. 3a and b and the molten thermoplastic upper material is applied onto heated thermoplastic rim portion 2′ and further on last 4 as a helical filament. Nozzle 6 is part of application unit 7 which is movable in the 3-dimensional space Alternatively, the application unit may be stationary and the last and sole unit may be moved in the 3-dimensional space relative to application unit 7.

Alternatively, path ii) may be pursued. In this embodiment, last 4 is arranged on sole unit 1 as described above. However, in this embodiment, heating the thermoplastic rim portion such that it becomes flowable and/or melts and/or softens is performed exclusively by transferring thermal energy from the molten thermoplastic upper material 5 being applied to the thermoplastic rim portion 2. Therefore, in contrast to path i) a separate heating step is not performed.

Since last 4 is arranged such on sole unit 1 that sole unit 1 and last 4 are flush with each other, the molten thermoplastic upper material is applied laterally and medially on sole unit 1. The dotted line in D indicates the interface of sole unit 1 and upper 8 being covered now by the thermoplastic upper material. Thermoplastic rim portion 2 is completely covered by the applied thermoplastic upper material.

Upon curing the molten thermoplastic upper material which has been applied to heated thermoplastic rim portion 2′ (see D) a locking engagement, in particular a material bonding engagement and optionally a form locking engagement is established between upper component 8 and sole unit 1. In this or any other embodiment described herein, the last 4 can then be removed to provide shoe component 100 (see E).

1. A method for producing a shoe component, the method comprising the steps of:
providing a sole unit, wherein the sole unit comprises a thermoplastic rim portion;
arranging a last on the sole unit;
heating the thermoplastic rim portion such that the thermoplastic rim portion becomes flowable and/or melts and/or softens to provide a heated thermoplastic rim portion;
applying a molten thermoplastic upper material onto the thermoplastic rim portion and/or onto the heated thermoplastic rim portion to produce an upper component; and
curing the heated thermoplastic rim portion and the molten thermoplastic upper material having been applied onto the thermoplastic rim portion and/or onto the heated thermoplastic rim portion to provide a locking engagement material between the upper component and the sole unit.

2. The method according to claim 1, wherein step d. the applying step further comprises applying the molten thermoplastic upper material onto the last to produce the upper component.

3. The method according to claim 1, wherein the molten thermoplastic upper material is applied onto the thermoplastic rim portion and/or onto the heated thermoplastic rim portion, as one or more thermoplastic filaments.

4. The method according to claim 1, wherein the thermoplastic rim portion is in step the heating step heated to a temperature of 110 °C to 350 °C.

5. The method according to claim 1, wherein the molten thermoplastic upper material is applied onto the thermoplastic rim portion and/or onto the heated thermoplastic rim portion by a nozzle.

6. The method according to claim 5, wherein the nozzle is part of an application unit movable in the 3-dimensional space.

7. The method according to claim 6, wherein the application unit and the last are moved relative to each other during the applying step.

8. The method according to claim 5, wherein the nozzle has an outlet opening for the molten thermoplastic upper material and a plurality of air exit openings, wherein the air exit openings are arranged around the outlet opening and wherein pressurized air is supplied to the molten thermoplastic upper material exiting the outlet opening such that the molten thermoplastic upper material which has exited from the nozzle is applied onto the thermoplastic rim portion and/or onto the heated thermoplastic rim portion and/or onto the last as a helical filament.

9. The method according to claim 1, wherein heating is performed by an IR heater by applying a stream of heated air and/or by a heating element being in direct contact with the thermoplastic rim portion.

10. The method according to claim 1, wherein the sole unit comprises a central section wherein the thermoplastic rim portion completely circumferentially surrounds the central section.

11. The method according to claim 10, wherein the last is arranged on the central section in the arranging step.

12. The method according to claim 10, wherein the molten thermoplastic upper material is applied onto the thermoplastic rim portion and/or onto the heated thermoplastic rim portion such that it circumferentially completely surrounds the central section.

13. The method according to claim 1, wherein the thermoplastic rim portion has a width of between >0 mm to 5 mm.

14. The method according to claim 1, previous claims, wherein the upper component and the sole unit are connected only by the locking engagement and/or wherein a connection of the upper component and the sole unit is devoid of stitching and/or a separate gluing agent.

15. A shoe, being obtainable by the method according to claim 1, the shoe comprising a sole unit and an upper component, wherein the sole unit comprises a thermoplastic rim portion and wherein the upper component is made from a thermoplastic upper material, wherein the sole unit and the upper component are connected with each other by a direct material bonding engagement between the thermoplastic rim portion and the upper component.

16. The shoe component according to claim 15, wherein the connection between the sole unit and the upper component is devoid of stitching and/or a separate gluing agent.

17. A method for producing a shoe component the method comprising the steps of:
providing a sole unit, wherein the sole unit comprises a thermoplastic rim portion;
arranging a last on the sole unit;
applying a molten thermoplastic upper material onto the thermoplastic rim portion to produce an upper component and thereby heating the thermoplastic rim portion such that the thermoplastic rim portion becomes flowable and/or melts and/or softens to provide a heated thermoplastic rim portion; and
curing the heated thermoplastic rim portion and the molten thermoplastic upper material having been applied onto the thermoplastic rim portion to provide a locking engagement between the upper component and the sole unit.

18. A method for producing a shoe component the method comprising the steps of:
providing a sole unit, wherein the sole unit comprises a thermoplastic rim portion;
arranging a last on the sole unit;
applying a molten thermoplastic upper material onto the thermoplastic rim portion with a nozzle to produce an upper component and thereby heating the thermoplastic rim portion to provide a heated thermoplastic rim portion, wherein the molten thermoplastic upper material forms a helical filament between the thermoplastic rim portion and the nozzle; and
curing the heated thermoplastic rim portion and the molten thermoplastic upper material having been applied onto the thermoplastic rim portion to provide a locking engagement between the upper component and the sole unit.
